(19) United States
(12) Patent Application Publication
(10) Pub. No.: US 2025/0289400 A1
(43) Pub. Date: Sep. 18, 2025

(54) DEVICE FOR CLEANING AN OPTICAL SURFACE OF A SENSOR, DETECTION SYSTEM AND METHOD OF MANUFACTURE

(71) Applicant: VALEO SYSTEMES D'ESSUYAGE, La Verriere (FR)

(72) Inventors: Denis THEBAULT, La Verriere (FR); Yoann DOLLE, La Verrière (FR); William TERRASSE, La Verrière (FR)

(73) Assignee: VALEO SYSTEMES D'ESSUYAGE, La Verriere (FR)

(21) Appl. No.: 18/861,247

(22) PCT Filed: Apr. 26, 2023
(86) PCT No.: PCT/EP2023/061052

§ 371 Date: Oct. 29, 2024

(30) Foreign Application Priority Data
May 3, 2022 (FR) 2204186

(51) Int. Cl. B60S 1/56; B05B 1/20; B05B 1/26

(52) U.S. Cl. CPC B60S 1/56; B05B 1/205; B05B 1/267

(57) ABSTRACT

A device for cleaning an optical surface of a sensor of a vehicle including at least one segment that has a circular-arc shape with a cleaning fluid circulation channel. The segment including at least one cleaning fluid inlet in the channel and at least one nozzle for spraying cleaning fluid toward the optical surface from the fluid circulation channel. The at least one nozzle includes a cleaning fluid outlet duct and a deflector, and the deflector extends in line with the duct, the deflector being able to deflect the flow of cleaning fluid by a given angle toward the optical surface.

### TECHNICAL FIELD

The invention relates to a device for cleaning an optical surface of a vehicle sensor, a detection system, and a method of manufacture.

### BACKGROUND OF THE INVENTION

Motor vehicles are increasingly fitted with optical elements, such as position sensors. The function of the position sensors is to gather information about the area surrounding the vehicle, in particular to assist the driver in driving and/or maneuvering this vehicle. To this end, a sensor is commonly installed on the vehicle so as to collect information about the area surrounding the vehicle. However, such sensors are particularly exposed to dirt such as dirty water, dust or other types of spray. This dirt hinders the transmission and reception of information and may disrupt the operation of the sensor, or even stop it from operating.

The use of devices for cleaning an optical surface of sensors so as to remove this dirt from them has been proposed. The problem is that these cleaning devices have a complex structure and do not enable the entire surface of the sensor to be cleaned. The sensor then does not work correctly.

There is a need for a device for wiping an optical surface of a sensor of a vehicle that solves this problem.

### SUMMARY OF THE INVENTION

The aim of the invention is to provide a device for cleaning an optical surface of a sensor of a vehicle that enables the entire surface of the sensor to be cleaned.

For this purpose, the invention provides a device for cleaning an optical surface of a sensor of a vehicle, the device comprising at least one segment that has a circular-arc shape with a cleaning fluid circulation channel, the at least one segment comprising at least one cleaning fluid inlet in the channel and at least one nozzle for spraying cleaning fluid toward the optical surface from the fluid circulation channel, wherein the at least one nozzle includes a cleaning fluid outlet duct and a deflector, and the deflector extends in line with the duct, the deflector being able to deflect the flow of cleaning fluid by a given angle toward the optical surface.

According to a variant, the at least one segment comprises a plurality of nozzles with a deflector, the deflectors being able to deflect the flow of cleaning fluid by a first angle or a second angle that is different from the first angle toward the optical surface.

According to a variant, the deflector has a first section arranged in line with the duct and a second section deflecting the fluid flow toward the optical surface by a given angle.

According to a variant, the at least one segment comprises a base and a cover together delimiting the cleaning fluid circulation channel, the nozzle duct extending through the cover to the deflector.

According to a variant, the cover comprises ribs stressing the base of the channels.

According to a variant, the nozzle duct forms an angle of 90°, or is inclined in relation to a normal to the cover.

According to a variant, the nozzle duct opens into the circulation channel through a stud on the cover.

According to a variant, the at least one segment comprises a plurality of nozzles that have a deflector able to deflect the flow of cleaning fluid by the same angle and that are positioned on radiuses of different lengths on the circular arc.

The invention also relates to a detection system comprising an optical sensor of a vehicle and a cleaning device as described above, the device being configured to clean the optical surface of the sensor.

According to a variant, the sensor has a cylindrical optical surface, the nozzles of the device being designed to direct the flow of cleaning fluid at different angles onto the optical surface.

The invention also relates to a method for manufacturing a cleaning device as described above, the at least one segment of the device comprising a cover, the method comprising a step of molding the segment cover using a pin to define the duct and a shim to partially define the deflector, the pin fitting into the shim.

All of the preferred embodiments and all of the advantages of the cleaning device according to the invention can be transferred, mutatis mutandis, to the present detection system and to the method, and vice versa. The different embodiments may be taken in combination or considered in isolation.

### BRIEF DESCRIPTION OF DRAWINGS

Further features and advantages of the present invention will become apparent from reading the following detailed description, for the understanding of which reference will be made to the appended figures, in which:

FIG. 1 shows a cleaning device in a detection system;

FIG. 2 shows a detail of the cleaning device;

FIG. 3 shows an example embodiment of another detail of the cleaning device;

FIG. 4 shows another example embodiment of a detail of the cleaning device;

FIG. 5 shows yet another example embodiment of a detail of the cleaning device.

The drawings in the figures are not to scale. Similar elements are generally denoted by similar references in the figures. In the context of this document, identical or similar elements may bear the same references. Furthermore, the presence of reference numbers or letters in the drawings cannot be considered limiting, including when these numbers or letters are indicated in the claims.

### DETAILED DESCRIPTION OF THE INVENTION

The invention provides a device for cleaning an optical surface of a sensor of a vehicle, the device comprising at least one segment that has a circular-arc shape with a cleaning fluid circulation channel. The at least one segment comprises at least one cleaning fluid inlet in the channel and at least one nozzle for spraying cleaning fluid toward the optical surface from the fluid circulation channel. In this device, the at least one nozzle includes a cleaning fluid outlet duct and a deflector. The deflector extends in line with the duct and is able to deflect the flow (or jet) of cleaning fluid by a given angle toward the optical surface. The conveyance and deflection of the fluid are improved by a simple structure. The entire surface of the sensor is cleaned better, which enables the sensor to operate correctly.

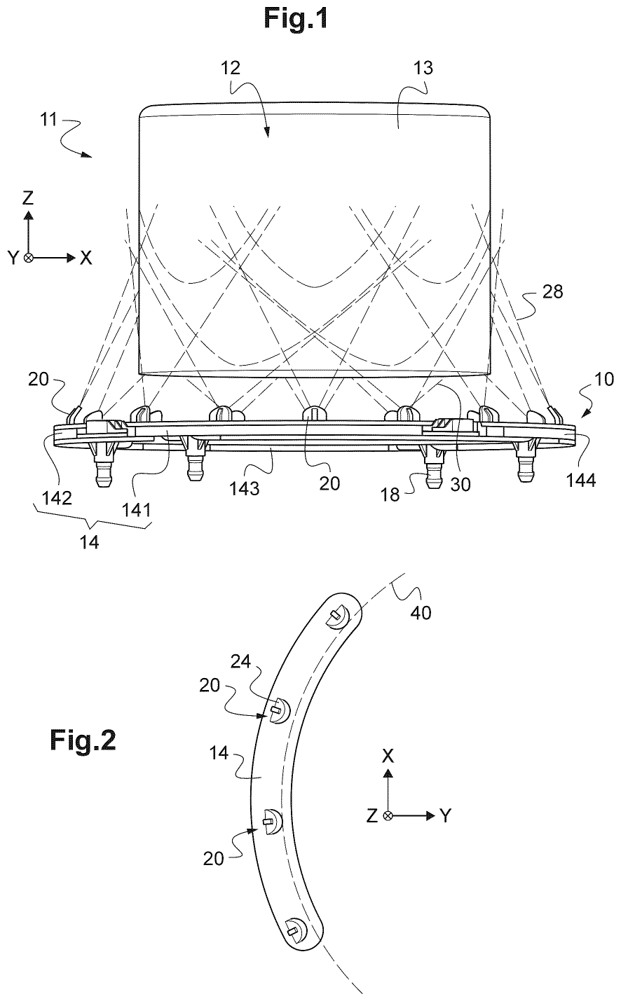

FIG. 1 shows a cleaning device 10 in a detection system 11. The cleaning device 10 may notably be used in a detection system 11 of a vehicle comprising a sensor 12. The sensor 12 makes it possible to gather information on the position of and the area surrounding the motor vehicle, in particular to assist the driver in driving and/or maneuvering this vehicle. The sensor 12 is installed on the vehicle so as to collect information on the area to the front, rear and/or side of the vehicle: the sensor 12 is for example installed at the front end and/or at the rear end. The sensor 12 may be an optical sensor. The sensor 12 is for example a LIDAR, which stands for “light detection and ranging” or “laser imaging, detection, and ranging”.

The sensor 12 interacts with the surrounding area through an optical surface 13. This may be a protective surface between the optical element and the surrounding area. For example, it may be a surface of a pane fitted between the sensor and the surrounding area, or a surface of a casing which encloses a sensor (such as a face of a LIDAR casing). The surface may be opaque (to the visible wavelengths). The surface may be transparent to the emission and reception wavelengths of the sensor 12. It is also possible to envisage multiple sensors interacting with the surrounding area through a single optical surface.

The shape of the optical surface 13 may vary according to the location and use of the sensor 12 in the vehicle and depending on the available space around the sensor. The optical surface 13 may have rounded portions and rectilinear portions. As shown in FIG. 1, the optical surface 13 has a cylindrical shape.

The device 10 comprises one or more segments 14. As shown in FIG. 1, the device for example comprises four segments 141, 142, 143, 144, although the device 10 could comprise a different number of segments. The segments 14 may be configured to be fastened in pairs.

The segments may be identical or have different shapes. The shape of the segments is therefore adapted to the shape of, and the area surrounding, the optical surface 13. The segments 14 form modules; the segments 14 are modules that are independent from one another. In the device 10, at least some of the segments are identical modules; this makes it possible to assemble the device simply but also to replace faulty segments simply. This makes it easier to manufacture the device. As shown in FIG. 1, all the segments are identical modules.

The segments 14 have a shape which is elongate between two ends. The segments 14 are configured to be fastened to one another so as to form a circular arc. A circular arc is a portion of a curve that is delimited by two points of this curve; a circular arc is a portion of the circumference of a circle with a center and a radius. The circular arc defines an axial direction Z which passes through the center of the circular arc, a radial direction Y which follows a radius of the circular arc, and a tangential direction X which is tangential to the circular portion of the circular arc. The circular arc may extend in a plane, which is to say a two-dimensional space, but may also be shaped such that the circular arc is partially in a plane and extends in three dimensions. The specific shape of each segment 14 depends on the shape of the optical surface 13. At least some of the segments are circular arcs, as defined above. This makes it possible to at least partially surround the optical surface 13.

FIG. 2 shows a detail of the cleaning device, i.e. an example segment 14. The segment 14 has a circular-arc shape, as defined above. A segment may be within a plane or include an inclination between the ends thereof. In a bottom view, the segment 14 is still a circular arc. The shape of the segment also depends on the area surrounding the optical surface 13 and is adapted to the available space around the optical surface 13. The segments 14 may have a circular-arc shape which differs from one segment to the next. This makes it possible to adapt it to the shape of, and the area surrounding, the optical surface 13.

Some segments 14 may have a circular-arc shape and some segments may have a rectilinear shape or indeed any shape at all. The shape of the device is such that the segments face the optical surface 13. The optical surface 13 is at least partially surrounded by the device 10 (at least in the portions through which the one or more sensors 12 interact with the surrounding area and that are to be cleaned). The device 10 may have a closed shape (as in FIG. 1) or an open shape. The device 10 may have a circular overall shape with the directions X, Y, Z defined above. As shown in FIG. 1, it is possible to envisage that the segments 14 form an annular structure. Two, three, four (or more) segments 14 may for example form an annular structure.

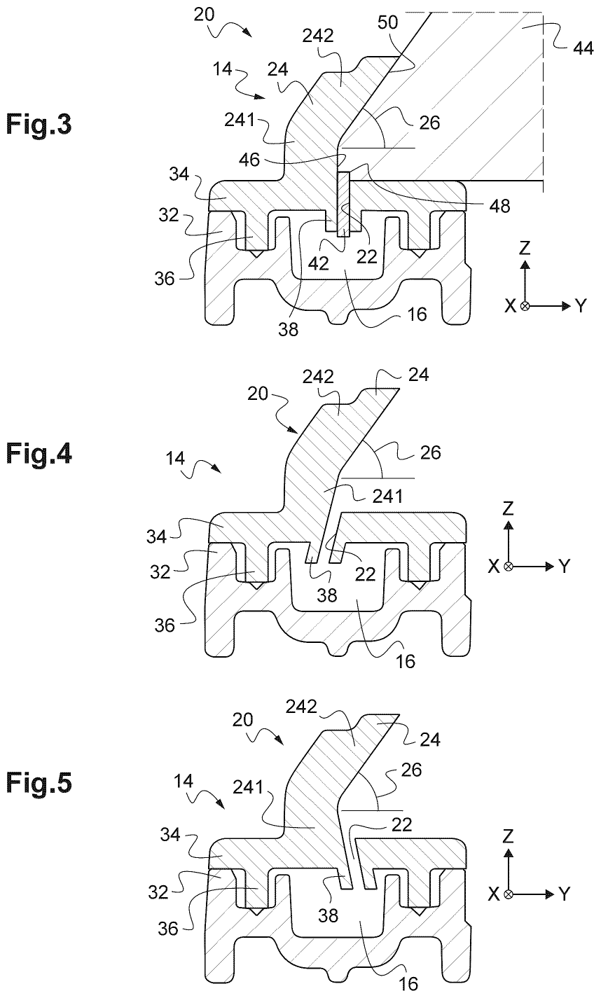

As shown in FIG. 3 to FIG. 5 showing a segment 14 in cross section, each of the segments 14 comprises a cleaning fluid circulation channel 16. The channel 16 in the segments is a flow duct with a hollow and elongate form, enabling passage of the fluid for cleaning the optical surface 13. The channel 16 follows the shape of the segment 14, i.e. a circular arc as described above. Each channel 16 extends over at least some of the length of the respective segment 14, but does not extend from one segment to another; a channel 16 defines a flow duct specific to each segment 14. Since the channels 16 are independent of one another, the device may have an open shape, such as an open loop.

As shown in FIG. 1, each of the segments 14 comprises at least one cleaning fluid inlet 18 in the channel 16 and at least one nozzle 20 for spraying the cleaning fluid toward the optical surface 13 from the channel 16. The inlet 18 is connected to a cleaning fluid distribution network and supplies cleaning fluid to the channel 16. Each segment 14 therefore comprises its own fluid inlet 18; fluid is then supplied to each of the segments 14 independently. The inlet 18 may extend along the axis Z, but another shape, such as an “L” shape, may be used to fit the area surrounding the sensor. The channel 16 of each segment 14 then makes it possible to distribute cleaning fluid to the one or more fluid spray nozzles 20. Four nozzles 20 are shown by way of example on the segment 14 in FIG. 2. The segments have a number of nozzles 20 which is specific to them, depending on the location of the segments 14 in relation to the optical surface 13 and in relation to the portion of the optical surface 13 that is to be cleaned. Similarly, the nozzles 20 are distributed over each segment 14 depending on the portion of the optical surface 13 that is to be cleaned.

FIG. 3 to FIG. 5 show the fluid circulation channels 16 in detail. In particular, FIG. 3 to FIG. 5 show the nozzles 20 including a cleaning fluid outlet duct 22 and a deflector 24. The deflector 24 extends in line with the duct 22. The duct 22 is tangential to the deflector 24. The deflector 24 is able to deflect the flow of cleaning fluid by a given angle 26 toward the optical surface 13. The deflector extends the conduit 22. The fluid flow comes out of the channel 16 in line with the duct 22, before being deflected. There is a gap between the outlet of the channel 16 and the deflection zone. The fluid flow is not deflected directly at the outlet of the channel 16. This creates a good quality fluid flow coming out of the duct 22, which is then deflected toward the optical surface 13. In other words, this provides a flow that has a better shape and is more homogeneous and more compact and is therefore better oriented toward the optical surface 13. The flows directed toward the optical surface 13 have an improved profile. This prevents fluid loss at the outlet of the channel, and therefore wastage of cleaning fluid.

The deflector 24 can deflect the flow by a deflection angle 26 defined as a function of the position of the nozzle in relation to the sensor 12. The at least one segment 14 can comprise a plurality of nozzles 20 with the deflector 24, the deflectors 24 being able to deflect the flow of cleaning fluid by a first angle 26 or a second angle 26 that is different from the first angle toward the optical surface. As shown in FIG. 1, the nozzles 20 deflect the fluid flow by different deflection angles 26. At a first angle 26, the fluid flow 28 is deflected higher than the flow 30 deflected by another angle 26. This better covers the surface 13 of the sensor, thereby improving cleaning of the optical surface 13. Since the flow 28 is deflected higher than the flow 30, the spray angle of the flow 28 can be less than the spray angle of the flow 30, and vice versa (the spray angle corresponding to the opening of the flow in relation to the optical surface 13). The quality of the flow obtained with the deflector 24 in line with the duct 22 improves control of the spray angle of the flows 28, 30 obtained by the nozzles 20, which improves cleaning quality. Furthermore, the device is not limited to two potential deflection angles 26. The deflection angle 26 is adjusted as a function of the position of the nozzles and the surface to be cleaned.

As shown in FIG. 3 to FIG. 5, the deflector 24 has a first section 241 arranged in line with the duct 22 and a second section 242 deflecting the fluid flow toward the optical surface 13 by a given angle 26. The section 241 extends the fluid flow outside the channel 16 in line with the duct 22. The section 242 then orients or deflects the fluid flow according to the flows 28 or 30 in FIG. 1. The section 241 creates a gap between the outlet of the channel 16 and the deflection zone provided by the section 242. This enhances the quality of the flow and therefore the advantages mentioned above.

As shown in FIG. 3 to FIG. 5, the segment or segments 14 may comprise a base 32 and a cover 34 together delimiting the cleaning fluid circulation channel 16, the nozzle duct 22 extending through the cover 34 to the deflector 24. This facilitates manufacture of the channel 16 and of the duct 22. The duct 22 through the cover 34 is manufactured in a simpler manner. The cover 34 can be fastened to the base 32 by welding, laser welding, snap fitting, bonding or screwing. The cover 34 may comprise ribs 36 stressing the base 32 of the channels 16. This improves the fluidtightness of the segments 14, thereby preventing cleaning fluid losses. More specifically, the channel 16 is between two ribs 36. The ribs 36 and the channel 16 of the segment 14 are concentric in a circular arc. The end of the ribs 36 may be welded, for example using ultrasound, onto the base 32. The cover 34 may also rest on the perimeter of the base 32 to further enhance the fluidtightness of the segments.

FIG. 3 to FIG. 5 show different examples of the duct 22 through the cover 34 of the segment 14. In particular, these figures show different inclinations of the duct 22 in the cover 34. This helps to control the deflection angle of the flow and cleaning quality. In all of these figures, the deflector 24 and, in particular, the part 241 are in line with the duct 22. The deflector 24 projects from the cover 34, the section 241 connecting the section 242 to the cover. As shown in FIG. 3 the nozzle duct 22 is orthogonal to the cover 34. The duct forms an angle of 90° with the cover. This defines a deflection angle 26 of the flow toward the midpoint of the height of the optical surface 13. As shown in FIG. 4, the duct 22 is inclined in relation to a normal to the cover 34. The duct 22 is directed more toward the inside of the circular arc defined by the segment 14 (in the direction Y). From the 90° position in FIG. 3, the duct 22 is inclined in the clockwise direction. This defines a deflection angle of the flow toward the bottom of the optical surface 13. As shown in FIG. 5, the duct 22 is inclined in relation to a normal to the cover 34. The duct 22 is directed more toward the outside of the circular arc defined by the segment 14 (opposite the direction Y). From the 90° position in FIG. 3, the duct 22 is inclined in the counter-clockwise direction. This defines a deflection angle of the flow toward the top of the optical surface 13.

The nozzle duct 22 can open into the circulation channel 16 through a stud 38 on the cover. FIG. 3 to FIG. 5 show the stud 38. The stud 38 is an overthickness of the internal face of the cover 34, oriented toward the inside of the channel 16. This enables the length of the duct 22 to be extended. This improves guidance of the fluid flow coming out of the cover 34. This improves the shape of the fluid flow coming out of the cover 34. This enables the thickness of the cover 34 to be reduced without adversely affecting the quality of the flow formed by the nozzle.

The segment or segments 14 may comprise a plurality of nozzles 20 that have a deflector 24 able to deflect the flow of cleaning fluid by the same angle and that are positioned on radiuses 40 of different lengths on the circular arc. FIG. 2 shows this feature. FIG. 2 shows a circular-arc segment 14 with nozzles 20 arranged radially in different positions. The nozzles 24 are offset radially in relation to one another on the segment 14. Along a radius 40 of a given length, two nozzles 20 are positioned on a circular arc, each one having a deflector with a different flow deflection angle 26. Along another radius of a different length, two nozzles 20 are positioned on a circular arc, each one having a deflector with a different flow deflection angle 26. This prevents the flows from being coplanar and hitting one another. This optimizes the flows and cleaning of the optical surface 13.

The invention also relates to the detection system 11 shown in FIG. 1, comprising the sensor 12 of a vehicle and the cleaning device 10. The device 10 is configured to clean the optical surface 13 of the sensor. The nozzles 20 of the device are designed to direct the flow of cleaning fluid at different angles onto the optical surface. According to one embodiment, the optical surface 13 of the sensor 12 is cylindrical, the segments 14 forming an annular structure around at least one part of the circumference of the optical surface. The described advantages of the device 10 apply to the system 11.

The invention also relates to a method for manufacturing the cleaning device 10. As shown in FIG. 3, the method comprises a step of molding the cover 34 of the segment 14 using a pin 42 to define the duct 22 and a shim 44 to partially define the deflector 24, the pin 42 fitting into the shim 44. Thanks to the deflector 24, which extends in line with the duct 22 and which deflects the fluid with a gap in relation to the outlet of the duct 22, a larger space enables the shim 44 to have a tip 46 that is less fragile than in the prior art. This enables the pin 42 to bear against the shim 44. The pin 42 can be fitted into the tip 46 of the shim 44. The pin 42 can be fitted into a notch 48 in the tip 46 of the shim 44. This prevents a skin from forming on the surface of the cover 34 at the outlet of the duct 22. The cover 34 and in particular the duct 22 are easy to manufacture. There is no need for reworking after the operation to mold the cover. This method and advantages also apply to the embodiments in FIG. 4 and FIG. 5.

As shown in FIG. 3, the shim 44 has the tip 46 defining the section 241 of the deflector 24 and a front 50 defining the section 242 of the deflector 24. The inclination between the tip 46 and the front 50 defines the angle 26. The definition of the shim 44 enables the definition of the deflection angle 26 of the fluid flow. The presence of the section 241, which provides a gap between the outlet of the fluid from the duct 22 and the deflection zone, enables use of a shim 44 that is more solid at its tip 46, thereby providing a support for the pin 42. Furthermore, demolding is facilitated.

Furthermore, the stud 38 also facilitates manufacture of the duct 22. This enables the pin 42 to be lengthened without risk of breaking the pin. This also provides more options for the diameter of the duct. It is notably possible to reduce the diameter of the duct, since it is possible to use a pin 42 of small diameter.

The description and the advantages of the method relating to FIG. 3 also apply to FIG. 4 and FIG. 5. As shown in FIG. 4 and FIG. 5, the pin may be inclined in relation to the shim, which enables a wide range of inclinations of the duct. Furthermore, in FIG. 2 to FIG. 5, the duct 22 is not on the edge of the cover, which facilitates removal of the pin.

The advantages described for the device 10 apply to the system and to the method (as well as to the product obtained from the method) and vice versa.

The present invention has been described in relation to specific embodiments, which have purely illustrative value and should not be considered limiting. In general, it will be obvious to a person skilled in the art that the present invention is not limited to the examples illustrated and/or described above.

What is claimed is:

1. A device for cleaning an optical surface of a sensor of a vehicle, the device comprising at least one segment that has a circular-arc shape with a cleaning fluid circulation channel, the at least one segment including at least one cleaning fluid inlet in the channel and at least one nozzle for spraying cleaning fluid toward the optical surface from the fluid circulation channel, wherein
i. the at least one nozzle includes a cleaning fluid outlet duct and a deflector, and
ii. the deflector extends in line with the duct, the deflector being able to deflect the flow of cleaning fluid by a given angle toward the optical surface.

2. The device as claimed in claim 1, the at least one segment includes a plurality of nozzles with a deflector, the deflectors being able to deflect the flow of cleaning fluid by a first angle or a second angle that is different from the first angle toward the optical surface.

3. The device as claimed in claim 2, wherein the deflector has a first section arranged in line with the duct and a second section deflecting the fluid flow toward the optical surface by a given angle.

4. The device as claimed in claim 1, wherein the at least one segment includes a base and a cover together delimiting the cleaning fluid circulation channel, the nozzle duct extending through the cover to the deflector.

5. The device as claimed in claim 4, wherein the cover includes ribs stressing the base of the channels.

6. The device as claimed in claim 4, wherein the nozzle duct forms an angle of 90°, or is inclined in relation to a normal to the cover.

7. The device as claimed in claim 4, wherein the nozzle duct opens into the circulation channel through a stud on the cover.

8. The device as claimed in claim 7, wherein the at least one segment includes a plurality of nozzles that have a deflector able to deflect the flow of cleaning fluid by the same angle and that are positioned on radiuses of different lengths on the circular arc.

9. A detection system comprising an optical sensor of a vehicle and a cleaning device, the cleaning device being configured to clean the optical surface of the sensor and includes at least one segment that has a circular-arc shape with a cleaning fluid circulation channel, the at least one segment including at least one cleaning fluid inlet in the channel and at least one nozzle for spraying cleaning fluid toward the optical surface from the fluid circulation channel, wherein the at least one nozzle includes a cleaning fluid outlet duct and a deflector, and the deflector extends in line with the duct, the deflector being able to deflect the flow of cleaning fluid by a given angle toward the optical surface.

10. The system as claimed in claim 9, wherein the sensor has a cylindrical optical surface, the nozzles of the device being designed to direct the flow of cleaning fluid at different angles onto the optical surface.

11. A method for manufacturing a cleaning device, the cleaning device including includes at least one segment that has a circular-arc shape with a cleaning fluid circulation channel, the at least one segment including at least one cleaning fluid inlet in the channel and at least one nozzle for spraying cleaning fluid toward the optical surface from the fluid circulation channel, wherein the at least one nozzle includes a cleaning fluid outlet duct and a deflector, and the deflector extends in line with the duct, the deflector being able to deflect the flow of cleaning fluid by a given angle toward the optical surface and the at least one segment of the device includes cover, the method comprising molding the cover using a pin to define the duct and a shim to partially define the deflector, the pin fitting into the shim.
